(19) United States
(12) Patent Application Publication
(10) Pub. No.: US 2015/0091443 A1
(43) Pub. Date: Apr. 2, 2015

(54) LOAD DRIVING APPARATUS WITH CURRENT BALANCE FUNCTION

(71) Applicant: Beyond Innovation Technology Co., Ltd., Taipei City (TW)

(72) Inventors: Zhen-Chun Liu, Taipei City (TW); Chen-Lung Kao, Taipei City (TW)

(73) Assignee: Beyond Innovation Technology Co., Ltd., Taipei City (TW)

(21) Appl. No.: 14/279,325

(22) Filed: May 16, 2014

(30) Foreign Application Priority Data
Oct. 1, 2013 (TW) 102135526

(51) Int. Cl. H05B 37/03

(52) U.S. Cl. CPC H05B 37/03
USPC 315/121

(57) ABSTRACT

A load driving apparatus including a power conversion circuit, a current balance circuit, a protection unit and a control chip is provided. The power conversion circuit is configured to receive a DC input voltage, and provide a DC output voltage to a plurality of light emitting units in response to a control signal. The current balance circuit has a plurality of switch elements corresponding to the light emitting units, and is configured to balance currents flowing through the light emitting units. The protection unit detects statuses of the switch elements and/or the DC output voltage. The control chip generates the control signal to control operations of the power conversion circuit; and stops generating the control signal and enters into a shutdown status when any one of the switch elements is open-circuit and/or the DC output voltage is over-voltage, thereby protecting the load driving apparatus and/or the switch elements from damaging.

### CROSS-REFERENCE TO RELATED APPLICATION

This application claims the priority benefit of Taiwan application serial no. 102135526, filed on Oct. 1, 2013. The entirety of the above-mentioned patent application is hereby incorporated by reference herein and made a part of this specification.

### BACKGROUND OF THE INVENTION

1. Field of the Invention

The invention relates a load driving technique, and more particularly, relates to a load driving apparatus with current balance function.

2. Description of Related Art

Currently, a load driving apparatus with current balance function is provided, which is configured to provide a DC output voltage for loads such as a plurality of light emitting units to use. However, when a switch element located on a current path of each of the light emitting units fails (e.g., open-circuit), stability for entire circuitry of the load driving apparatus may be affected accordingly, and worse yet, it may cause damages to the loads and the load driving apparatus.

### SUMMARY OF THE INVENTION

Accordingly, the invention is directed to a load driving apparatus capable of detecting whether a switch element located on a current path of each of the light emitting units fails (e.g., open-circuit), so as to effectively solve the problem addressed in Description of Related Art.

Other objects and advantages of the invention can be further illustrated by the technical features broadly embodied and described as follows.

Herein, an exemplary embodiment of the invention provides a load driving apparatus, which includes a power conversion circuit, a current balance circuit, a protection unit and a control chip. The power conversion circuit is configured to receive a DC input voltage, and provide a DC output voltage to a plurality of light emitting units in response to a control signal. The current balance circuit is coupled to the light emitting units and includes a plurality of switch elements corresponding to the light emitting units. The current balance circuit is configured to balance currents flowing through the light emitting units. The protection unit is coupled to a plurality of common nodes between the light emitting units and the switch elements and the DC output voltage, and configured to detect statuses of the switch elements and/or the DC output voltage. The control chip is coupled to the power conversion circuit and the protection unit, and configured to: generate the control signal to control operations of the power conversion circuit; and stop generating the control signal and enter into a shutdown status when any one of the switch elements is open-circuit and/or the DC output voltage is over-voltage, thereby protecting the load driving apparatus and/or the switch elements from damaging.

In an exemplary embodiment of the invention, the switch elements are implemented by adopting a plurality of transistors having identical characteristics.

In an exemplary embodiment of the invention, the protection unit may include: a plurality of switch detection circuits and an over-voltage detection circuit. Each of the switch detection circuits is configured to detect whether the corresponding transistor is open-circuit. In addition, the over-voltage detection circuit is configured to detect whether the DC output voltage is over-voltage.

In an exemplary embodiment of the invention, once the switch detection circuits detect that any one of the transistors is open-circuit, the control chip stops generating the control signal and enters into the shutdown status. Alternatively, once the over-voltage detection circuit detects that the DC output voltage is over-voltage, the control chip stops generating the control signal and enters into the shutdown status.

Based on above, the load driving apparatus proposed by the invention is capable of making the control chip to start a protection mechanism to stop generating/outputting the control signal for controlling the operations of the power conversion circuit and enter into the shutdown status when the switch elements (the transistors) on the current path of each of the light emitting units fails (e.g., open-circuit) and/or the DC output voltage provided to the load is over-voltage. Accordingly, the load driving apparatus and/or the load may be protected from damaging, so as to effectively overcome/solve the problem addressed in Description of Related Art.

To make the above features and advantages of the present disclosure more comprehensible, several embodiments accompanied with drawings are described in detail as follows.

However, the above descriptions and the below embodiments are only used for explanation, and they do not limit the scope of the disclosure.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a system block diagram illustrating a load driving apparatus 10 according to an exemplary embodiment of the invention.

FIG. 2 is a schematic diagram illustrating an implementation of the load driving apparatus 10 depicted in FIG. 1.

### DESCRIPTION OF THE EMBODIMENTS

Descriptions of the invention are given with reference to the exemplary embodiments illustrated with accompanied drawings, in which same or similar parts are denoted with same reference numerals. In addition, whenever possible, identical or similar reference numbers stand for identical or similar elements in the figures and the embodiments.

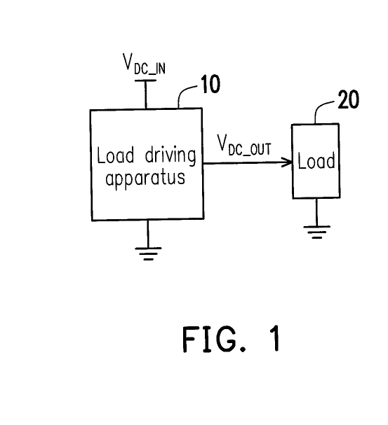

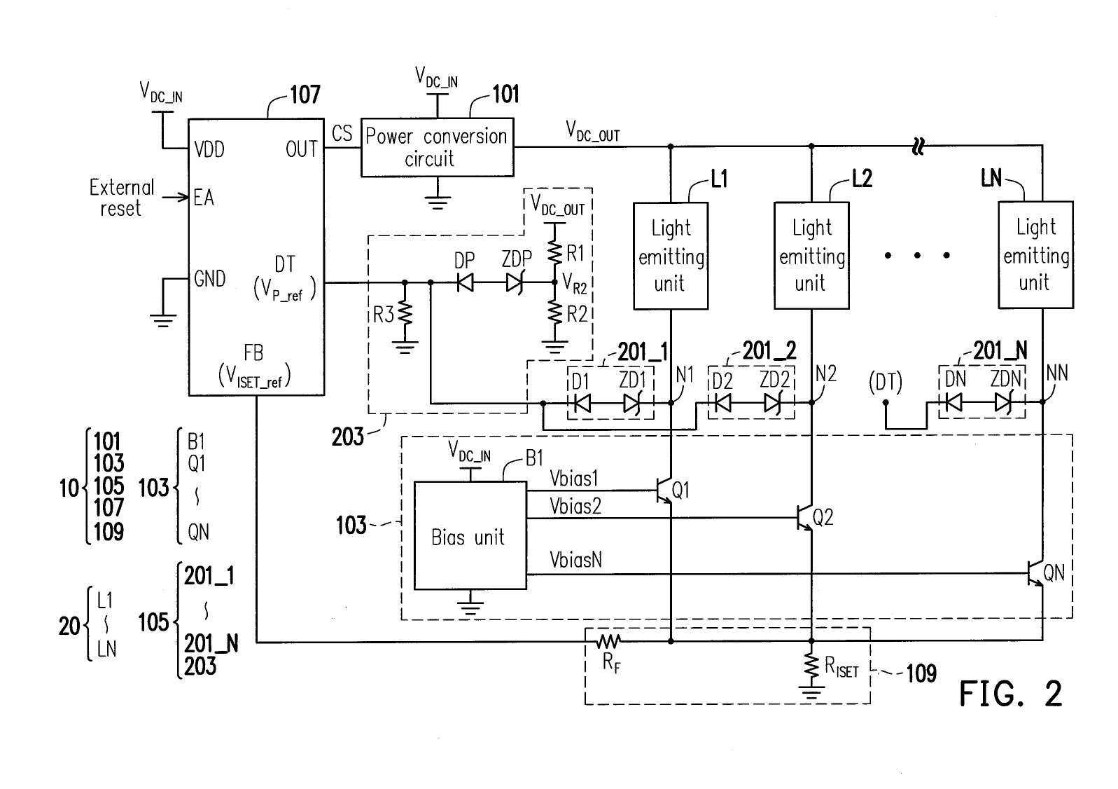

FIG. 1 is a system block diagram illustrating a load driving apparatus 10 according to an exemplary embodiment of the invention, and FIG. 2 is a schematic diagram illustrating an implementation of the load driving apparatus 10 depicted in FIG. 1. Referring to FIG. 1 and FIG. 2 together, the load driving apparatus 10 is adapted to provide a DC output voltage V_{DC}_{_{—}}_{OUT} to a load 20 of any type, such as a plurality of light emitting units L1 to LN in a backlight module for a LCD system, but the invention is not limited thereto. The load driving apparatus 10 includes a power conversion circuit 101, a current balance circuit 103, a protection unit 105, a control chip 107, and a current-setting circuit 109.

It is pre-mentioned that, the control chip 107 may include a plurality of functional pins, such as a power pin VDD, a ground pin GND, a chip enable pin EA, an output pin OUT, a detection pin DT, and a feedback pin FB. Naturally, based on practical design/application requirements, other functional pins may be added to the control chip 107, or the existed functional pins may be removed from the control chip 107. Moreover, in order to accomplish purposes of protecting circuits and setting currents, the control chip 107 may also be built-in with a protection reference voltage V_{P}_{_{—}}_{ref} and a current-setting reference voltage V_{ISET}_{_{—}}_{ref}. Similarly, based on practical design/application requirements, the control chip 107 may also be built-in with other reference voltages to accomplish different protection/setting purposes.

In the present exemplary embodiment, the power conversion circuit 101 may be a PWM-based power conversion circuit, but the invention is not limited thereto. Under this condition, the power conversion circuit 101 may be configured to receive a DC input voltage V_{DC}_{_{—}}_{IN}, and provide the DC output voltage V_{DC}_{_{—}}_{OUT} in response to a control signal CS (e.g., a PWM control signal) for the load 20 such as the light emitting units L1 to LN to use. It is worth mentioning that, a topology pattern of the power conversion circuit 101 may be a boost type, a buck type, a buck/boost type or other types of power conversion topology, which is all depending on the practical design/application requirements.

On the other hand, the current balance circuit 103 is coupled to the light emitting units L1 to LN, and includes a plurality of switch elements Q1 to QN corresponding to the light emitting units L1 to LN and a bias unit B1. In the present exemplary embodiment, the current balance circuit 103 may be configured to balance currents flowing through the light emitting units L1 to LN. Herein, in order accomplish a purpose of current balancing, the switch elements Q1 to QN may be implemented by adopting a plurality of transistors having identical characteristics (e.g., amplification factor, size), such as bipolar transistors (BJTs) or metal-oxide-semiconductor field emission transistors (MOSFETs), but the invention is not limited thereto. In addition, because reference numbers of the bipolar transistors are illustrated in FIG. 2 for example/illustration, thus the switch elements Q1 to QN are referred to as transistors Q1 to QN hereinafter.

In the current balance circuit 103, the bias unit B1 is coupled to the transistors Q1 to QN, and configured to operate under the DC input voltage V_{DC}_{_{—}}_{IN} and provide a plurality of bias voltages Vbias1 to VbiasN to control terminals (e.g., bases) of the transistors Q1 to QN. In addition, high-voltage terminals of the light emitting units L1 to L2 are coupled to the DC output voltage V_{DC}_{_{—}}_{OUT} generated/provided by the power conversion circuit 101, low-voltage terminals of the light emitting units L1 to L2 are respectively coupled to first terminals (e.g., collectors) of the transistors Q1 to QN to form a plurality of common nodes N1 to NN, and second terminals (e.g., emitters) of the transistors Q1 to QN are coupled to one another.

Further, the protection unit 105 is coupled to the common nodes N1 to NN between the light emitting units L1 to LN and the switch elements (i.e., the transistors Q1 to QN) and the DC output voltage V_{DC}_{_{—}}_{OUT}. Moreover, the protection unit 105 may be configured to detect statuses of the switch elements (i.e., the transistors Q1 to QN) and/or the DC output voltage V_{DC}_{_{—}}_{OUT}. More specifically, the protection unit 105 may include a plurality of switch detection circuits 201_1 to 201_N and an over-voltage detection circuit 203.

In the present exemplary embodiment, the switch detection circuits 201_1 to 201_N are respectively corresponding to the transistors Q1 to QN, and respectively coupled between the first terminals (the collectors) of the transistors Q1 to QN and the detection pin DT of the control chip 107. For instance, the switch detection circuit 201_1 is corresponding to the transistor Q1, and coupled between the first terminal (the collector) of the transistor Q1 and the detection pin DT of the control chip 107; the switch detection circuit 201_2 is corresponding to the transistor Q2, and coupled between the first terminal (the collector) of the transistor Q2 and the detection pin DT of the control chip 107; and the rest can be deduced from the above, for example, the switch detection circuit 201_N is corresponding to the transistor QN, and coupled between the first terminal (the collector) of the transistor QN and the detection pin DT of the control chip 107.

In terms of functionality, each of the switch detection circuits 201_1 to 201_N may be configured to detect whether the corresponding one of the transistors Q1 to QN is open-circuit. For instance, the switch detection circuit 201_1 may be configured to detect whether the corresponding transistor Q1 is open-circuit; the switch detection circuit 201_2 may be configured to detect whether the corresponding transistor Q2 is open-circuit; and the rest can be deduced from the above, for example, the switch detection circuit 201_N may be configured to detect whether the corresponding transistor QN is open-circuit.

In addition, in terms of implementation structure, each of the switch detection circuits 201_1 to 201_N may include a diode and a Zener diode. For instance, the switch detection circuit 201_1 may include a diode D1 and a Zener diode ZD1; the switch detection circuit 201_2 may include a diode D2 and a Zener diode ZD2; and the rest can be deduced from the above, for example, the switch detection circuit 201_N may include a diode DN and a Zener diode ZDN.

Furthermore, in terms of connectivity, taking the switch detection circuit 201_1 for example, a cathode of the diode D1 is coupled to the detection pin DT of the control chip 107, an anode of the Zener diode ZD1 is coupled to an anode of the diode D1, and a cathode of the Zener diode ZD 1 is coupled to the first terminal (the collector) of the corresponding transistor Q1. Similarly, taking the switch detection circuit 201_2 for example, a cathode of the diode D2 is coupled to the detection pin DT of the control chip 107, an anode of the Zener diode ZD2 is coupled to an anode of the diode D2, and a cathode of the Zener diode ZD2 is coupled to the first terminal (the collector) of the corresponding transistor Q2. The rest can be deduced from the above, for example, a cathode of the diode DN is coupled to the detection pin DT of the control chip 107, an anode of the Zener diode ZDN is coupled to an anode of the diode DN, and a cathode of the Zener diode ZDN is coupled to the first terminal (the collector) of the corresponding transistor QN.

On the other hand, the over-voltage detection circuit 203 is coupled between the DC output voltage V_{DC}_{_{—}}_{OUT} generated/provided by the power conversion circuit 101 and the detection pin. DT of the control chip 107. Moreover, in terms of functionality, the over-voltage detection circuit 203 may be configured to determine whether the DC output voltage V_{DC}_{_{—}}_{OUT} generated/provided by the power conversion circuit 101 is over-voltage. In terms of implementation structure, the over-voltage detection circuit 203 may include resistors R1 to R3, a diode DP and a Zener diode ZDP. In terms of connectivity, a first terminal of the resistor R1 is coupled to the DC output voltage V_{DC}_{_{—}}_{OUT} generated/provided by the power conversion circuit 101. The resistor R2 is coupled between a second terminal of the resistor R1 and a ground potential. A cathode of the diode DP is coupled to the detection pin DT of the control chip 107. An anode of the Zener diode ZDP is coupled to an anode of the diode DP, and a cathode of the Zener diode ZDP is coupled to the second terminal of the resistor R1. The resistor R3 is coupled between the detection pin DT of the control chip 107 and the ground potential.

In addition, in order to make the control chip 107 to operate normally, the power pin VDD receives the DC input voltage V_{DC}_{_{—}}_{IN} required for operations, and the ground pin GND is coupled to the ground potential. Accordingly, the control chip 107 may perform a conversion (e.g., boosting/bucking) to the DC input voltage V_{DC}_{_{—}}_{IN}, so as to obtain an operating voltage required for internal circuits (not illustrated) thereof.

In the present exemplary embodiment, the control chip 107 is coupled to the power conversion circuit 101 and the protection unit 105, and configured to: generate the control signal CS and output the control signal CS through the output pin OUT to control operations of the power conversion circuit 101; and when any one of the switch elements (e.g., the transistors Q1 to QN) is open-circuit and/or the DC output voltage V_{DC}_{_{—}}_{OUT} generated/provided by the power conversion circuit 101 is over-voltage, stop generating the control signal CS and enter into a shutdown/inactivation status, so as to protect the load driving apparatus 10 and/or the load 20 such as the light emitting units L1 to LN from damaging.

More specifically, when a voltage on any one of the common nodes N1 to NN minus a breakdown voltage of the corresponding Zener diode and then minus a forward bias of the corresponding diode is greater than the protection reference voltage V_{P}_{_{—}}_{ref} built-in the control chip 107, it indicates that at least one of the transistors Q1 to QN is open-circuit. In this condition, the control chip 107 stops generating the control signal CS and enters into the shutdown status. In contrast, under normal condition, a voltage on the detection pin DT of the control chip 107 is of low level and less than the built-in protection reference voltage V_{P}_{_{—}}_{ref}.

For instance, when a voltage (e.g., denoted by V_{N1}) on the common node N1 minus a breakdown voltage (e.g., denoted by V_{Z1}) of the corresponding Zener diode ZD1 and then minus a forward bias (e.g., denoted by V_{D1}) of the corresponding diode D1 is greater than the protection reference voltage V_{P}_{_{—}}_{ref} built-in the control chip 107 (i.e., V_{N1}−V_{Z1}−V_{D1}>V_{P}_{_{—}}_{ref}), it indicates that the transistor Q1 is open-circuit. In this condition, the control chip 107 stops generating the control signal CS (i.e., the power conversion circuit 101 no longer generates/provides the DC output voltage V_{DC}_{_{—}}_{OUT} to the load 20) and enters into the shutdown status.

For another instance, when a voltage (e.g., denoted by V_{N2}) on the common node N2 minus a breakdown voltage (e.g., denoted by V_{Z2}) of the corresponding Zener diode ZD2 and then minus a forward bias (e.g., denoted by V_{D2}) of the corresponding diode D2 is greater than the protection reference voltage V_{P}_{_{—}}_{ref} built-in the control chip 107 (i.e., V_{N2}−V_{Z2}−V_{D2}>V_{P}_{_{—}}_{ref}), it indicates that the transistor Q2 is open-circuit. In this condition, the control chip 107 also stops generating the control signal CS and enters into the shutdown status.

The rest can be deduced from the above, for example, when a voltage (e.g., denoted by V_{NN}) on the common node NN minus a breakdown voltage (e.g., denoted by V_{ZN}) of the corresponding Zener diode ZDN and then minus a forward bias (e.g., denoted by V_{DN}) of the corresponding diode DN is greater than the protection reference voltage V_{P}_{_{—}}_{ref} built-in the control chip 107 (i.e., V_{NN}−V_{ZN}−V_{DN}>V_{P}_{_{—}}_{ref}), it indicates that the transistor QN is open-circuit. In this condition, the control chip 107 also stops generating the control signal CS and enters into the shutdown status.

On the other hand, when a voltage division (e.g., denoted by V_{R2}) between the resistors R1 and R2 minus a breakdown voltage (e.g., denoted by V_{ZDP}) of the Zener diode ZDP and then minus a forward bias (e.g., denoted by V_{DP}) of the diode is greater than the protection reference voltage V_{P}_{_{—}}_{ref} built-in the control chip 107 (i.e., V_{R2}−V_{ZDP}−V_{DP}>V_{P}_{_{—}}_{ref}), it indicates that the DC output voltage V_{DC}_{_{—}}_{OUT} generated/provided by the power conversion circuit 101 is over-voltage. In this condition, the control chip 107 also stops generating the control signal CS and enters into the shutdown status.

Apparently, once the switch detection circuits 201_1 to 201_N detect that any one of the transistors Q1 to QN is open-circuit (hereinafter, referred to as a condition 1), the control chip 107 stops generating the control signal CS and enters into the shutdown status. Alternatively, once the over-voltage detection circuit 203 detects that the DC output voltage V_{DC}_{_{—}}_{OUT} generated/provided by the power conversion circuit 101 is over-voltage (hereinafter, referred to as a condition 2), the control chip 107 also stops generating the control signal CS and enters into the shutdown status. In other words, when either the condition 1 or the condition 2 is satisfied, the control chip 107 stops generating control signal CS and enters into the shutdown status. Accordingly, the load driving apparatus 10 and/or the load 20 may be protected from damaging, so as to effectively overcome/solve the problem addressed in Description of Related Art. It is worth mentioning that, since the control chip 107 stops generating the control signal CS enters into the shutdown status when either the condition 1 or the condition 2 is satisfied, a common endpoint for connecting each of the switch detection circuits 201_1 to 201_N and the over-voltage detection circuit 203 to the detection pin DT may be considered as in a manner of wire-OR gate.

Further, for the purpose of setting currents, in the present exemplary embodiment, the current-setting circuit 109 may be coupled to the second terminals (the emitters) of the transistors Q1 to QN and the feedback pin FB of the control chip 107. Moreover, in terms of functionality, the current-setting circuit 109 may be configured to set the currents flowing through the light emitting units L1 to LN. In terms of implementation structure, the current-setting circuit 109 may include resistors R_{ISET} and R_{F}. In terms of connectivity, a first terminal of the resistor R_{ISET} is coupled to the second terminals (the emitters) of the transistors Q1 to QN, and a second terminal of the resistor R_{ISET} is coupled to a ground potential. A first terminal of the resistor R_{F} is coupled to the second terminals (the emitters) of the transistors Q1 to QN, and a second terminal of the resistor R_{F} is coupled to the feedback pin FB of the control chip 107.

Herein, owing to the current-setting reference voltage V_{ISET}_{_{—}}_{ref} built-in the control chip 107, the currents flowing through the light emitting units L1 to LN may be decided based on the current-setting reference voltage V_{ISET}_{_{—}}_{ref} and a resistance of the resistor R_{ISET} (i.e., decided by the built-in current-setting reference voltage V_{ISET}_{_{—}}_{ref} divided by the resistance of the resistor R_{ISET}). Accordingly, the purpose of setting currents may be accomplished, so as to improve application range/environment for the load driving apparatus 10.

Furthermore, once the control chip 107 enters into the shutdown status in response to any one of the transistors Q1 to QN being open-circuit or in response to the DC output voltage V_{DC}_{_{—}}_{OUT} being over-voltage, the control chip 107 may be reset through the chip enable pin EA of the control chip 107 by an external part, so as to restore the control chip 107 from the shutdown status back to an activation status. Apparently, the control chip 107 belongs to a control chip of output latch type, wherein the so-called “output latch type” means that: once the control chip 107 enters into the shutdown status, the control signal CS is no longer generated/provided unless the control chip 107 is reset through the chip enable pin EA by the external part.

In addition, in order to accomplish a purpose of adjusting the DC output voltage V_{DC}_{_{—}}_{OUT}, in other exemplary embodiments of the invention, another functional pin may also be added to the control chip 107 to receive a feedback voltage associated with the DC output voltage V_{DC}_{_{—}}_{OUT} or the load 20, thereby adjusting the DC output voltage V_{DC}_{_{—}}_{OUT} to a default value/set value/established value. Alternatively, in order to accomplish a purpose of over current protection, another functional pin may be added to the control chip 107 to receive another feedback voltage associated with currents flowing through a power switching path of the power conversion circuit 101, thereby starting a protection mechanism when over-current occurs, so as to stop generating/outputting the control signal CS for controlling operations of the power conversion circuit 101 and enter into the shutdown status.

In summary, the load driving apparatus 10 proposed by the invention is capable of making the control chip 107 to start a protection mechanism to stop generating/outputting the control signal CS for controlling the operations of the power conversion circuit 101 and enter into the shutdown status when the switch elements (the transistors Q1 to QN) on the current path of each of the light emitting units L1 to LN fails (e.g., open-circuit) and/or the DC output voltage V_{DC}_{_{—}}_{OUT} provided to the load 20 is over-voltage. Accordingly, the load driving apparatus 10 and/or the load 20 may be protected from damaging, so as to effectively overcome/solve the problem addressed in

### DESCRIPTION OF RELATED ART

It is worth mentioning that, the load driving apparatus 10 is applied in the backlight module of the LCD system for examples, thus the LCD system and/or the backlight module having the load driving apparatus 10 both fall within the scope of the present invention for which protection is sought. In addition, the load driving apparatus 10 applied in the backlight module of the LCD system belongs to an exemplary illustration, thus application range/environment for the load driving apparatus 10 is not limited only to applications in said exemplary illustration.

Although the present invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

Any of the embodiments or any of the claims of the invention does not need to achieve all of the advantages or features disclosed by the present invention. Moreover, the abstract and the headings are merely used to aid in searches of patent files and are not intended to limit the scope of the claims of the present invention.

What is claimed is:

1. A load driving apparatus, comprising:
a power conversion circuit, configured to receive a DC input voltage, and provide a DC output voltage to a plurality of light emitting units in response to a control signal;
a current balance circuit, coupled to the light emitting units, having a plurality of switch elements corresponding to the light emitting units, and configured to balance currents flowing through the light emitting units;
a protection unit, coupled to a plurality of common nodes between the light emitting units and the switch elements and the DC output voltage, and configured to detect statuses of the switch elements and/or the DC output voltage; and
a control chip, coupled to the power conversion circuit and the protection unit, and configured to: generate the control signal to control operations of the power conversion circuit; and stop generating the control signal and enter into a shutdown status when any one of the switch elements is open-circuit and/or the DC output voltage is over-voltage, thereby protecting the load driving apparatus and/or the switch elements from damaging.

2. The load driving apparatus of claim 1, wherein the switch elements are implemented by adopting a plurality of transistors having identical characteristics, and the current balance circuit further comprises:
a bias unit, coupled to the transistors, and configured to operate under the DC input voltage and provide a plurality of bias voltages to control terminals of the transistors,
wherein high-voltage terminals of the light emitting units are coupled to the DC output voltage, low-voltage terminals of the light emitting units are respectively coupled to first terminals of the transistors to form the common nodes, and the second terminals of the transistors are coupled to one another.

3. The load driving apparatus of claim 2, wherein the control chip has a feedback pin, and the load driving apparatus further comprises:
a current-setting circuit, coupled to the second terminals of the transistors and the feedback pin, and configured to set the currents flowing through the light emitting units.

4. The load driving apparatus of claim 3, wherein the current-setting circuit comprises:
a first resistor, having a first terminal coupled to the second terminals of the transistors, and a second terminal coupled to a ground potential; and
a second resistor, having a first terminal coupled to the second terminals of the transistors, and a second terminal coupled to the feedback pin.

5. The load driving apparatus of claim 4, wherein:
the control chip has a built-in current-setting reference voltage; and
the currents flowing through the light emitting units are decided based on the current-setting reference voltage and a resistance of the first resistor.

6. The load driving apparatus of claim 2, wherein the control chip has a detection pin and has a built-in protection reference voltage, and the protection unit comprises:
a plurality of switch detection circuits, respectively corresponding to the transistors and respectively coupled between the first terminals of the transistors and detection pin, and each of the switch detection circuits being configured to detect whether the corresponding transistor is open-circuit; and
an over-voltage detection circuit, coupled between the DC output voltage and the detection pin, and configured to detect whether the DC output voltage is over-voltage.

7. The load driving apparatus of claim 6, wherein each of the switch detection circuits comprises:
a diode, having a cathode coupled to the detection pin; and
a Zener diode, having an anode coupled to an anode of the diode, and a cathode coupled to the first terminal of the corresponding transistor,
wherein when a voltage on any one of the common nodes minus a breakdown voltage of the corresponding Zener diode and then minus a forward bias of the corresponding diode is greater than the protection reference voltage, it indicates that at least one of the transistors is open-circuit, and then the control chip stops generating the control signal and enters into the shutdown status.

8. The load driving apparatus of claim 6, wherein the over-voltage detection circuit comprises:
a first resistor, having a first terminal coupled to the DC output voltage;
a second resistor, coupled between a second terminal of the first resistor and a ground potential;
a diode, having a cathode coupled to the detection pin;
a Zener diode, having an anode coupled to an anode of the diode, and a cathode coupled to the second terminal of the first resistor; and
a third resistor, coupled between the detection pin and the ground potential,
wherein when a voltage division between the first and second resistors minus a breakdown voltage of the Zener diode and then minus a forward bias of the diode is greater than the protection reference voltage, it indicates that the DC output voltage is over-voltage, and then the control chip stops generating the control signal and enters into the shutdown status.

9. The load driving apparatus of claim 1, wherein the power conversion circuit is a PWM-based power conversion circuit.

10. The load driving apparatus of claim 1, wherein:
the control chip comprises an output pin to output the control signal;
the control chip further comprises a chip enable pin for resetting by an external part to restore the control chip from the shutdown status back into an activation status;
the control chip further comprises a power pin to receive the DC input voltage required for operations, and
the control blade further comprises a ground pin to couple to the ground potential.
